(19) United States
(12) Patent Application Publication
(10) Pub. No.: US 2009/0019941 A1
(43) Pub. Date: Jan. 22, 2009

(54) PULL TEST CALIBRATION DEVICE AND METHOD

(75) Inventor: Robert John Sykes, Essex (GB)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 12/279,889

(22) PCT Filed: Mar. 8, 2007
(86) PCT No.: PCT/GB07/00806

§ 371 Date: Aug. 19, 2008

(30) Foreign Application Priority Data
Mar. 10, 2006 (GB) 0604914.2

(51) Int. Cl. G01N 3/08; G01D 18/00

(52) U.S. Cl. 73/826; 73/1.01

(57) ABSTRACT

A device and method permits absolute and relative calibration of a pull-test device for testing the mechanical strength of electrical bond deposits. The invention provides repeatable breaking of a test specimen such as a wire (11) indexable through an anvil (17). A test tool (12) is restrained against movement from the pull axis by a low friction support such as a roller (13). A rest (14) defines a start position. The test tool is moved against the test specimen to break the test specimen. A measuring device is provided to measure the force necessary to break the test specimen.

This invention relates to a method of calibrating a pull test device for testing the strength of miniature electrically conductive bonds of electrical equipment.

A substrate for use in electrical apparatus, such as a cell phone, typically defines electrical pathways for connecting electrical components thereof. In miniature devices electrical connections to the substrate are made via soldered or welded connections, and for this purpose electrically conductive balls, for example of solder, are formed on the component and re-flowed or welded when assembled to a mating substrate.

Typically a component may be in the range 5-50 mm and have solder balls thereon. Such components are often termed BGA's (ball grid arrays). These balls have the appearance of a low circular dome or squashed sphere, and have a diameter in the range 0.1-1.0 mm.

It is necessary to test the mechanical strength of the bond between the solder ball and the substrate in order to give confidence that the production bonding method is adequate, and that the bond strength is sufficient. One kind of test applies a tension load to the solder ball by gripping and pulling. In use a strong bond will result in ductile failure of the solder ball, with progressive deformation until the solder ball breaks away; in such a failure mode, part of the solder ball remains adhered to the substrate. A weak bond will typically exhibit brittle failure and tear away from the substrate leaving little residue adhered thereto.

The very small size of solder balls, and the low detected forces have resulted in the development of specialized test equipment.

In particular devices have been developed with jaws to grip a solder ball so as to exert a tension load. Very low forces are detected by the use of special low friction techniques and sensitive measuring apparatus.

A known pull test apparatus is the Model 4000 Series machine available from Dage Precision Industries, Ltd. of Aylesbury, United Kingdom. This device comprises a machine having a support surface and a test head movable in a controlled manner relative to the support surface. The test head carries a cartridge specific to the test to be performed and having one of several interchangeable gripping tools thereon. An example of such a cartridge is shown in U.S. Pat. No. 6,301,971. Typically the tool will be sized and/or shaped to suit the ball deposit to be tested. In use, the substrate to be tested is attached to the support surface, and the tool is mounted into the cartridge and positioned to grip the ball deposit prior to performing the required test. Typically the tool moves with respect to a stationary deposit.

It will be understood that a typical gripping tool is very small, and accordingly the cartridge has a flexible element on which is mounted one or more force gauges (such as strain gauges). Thus pulling force between the tool and the ball deposit is measured at a distance by deflection in the flexible elements of the cartridge.

One difficulty in pull testing devices is to be able to compare performance and/or to calibrate the force measuring apparatus against a known and repeatable standard. Since the bonding method of solder balls cannot be repeated with absolute assurance, some other technique is required.

According to a first aspect of the present invention there is provided a comparison method for determining performance of a pull test device and comprising the steps of:

determining a pull axis of a pull test device, fitting to said device a test tool having an abutment face perpendicular to said axis and facing the direction of pull;
providing adjacent an edge of said face a relatively fixed member having a hole therein having a longitudinal axis perpendicular to said pull axis;
inserting a close fitting test specimen such as a wire through said hole to protrude therefrom on the test tool side;
supporting said tool in a low friction manner against forces tending to cause misalignment from said axis;

breaking said wire with said abutment face by movement of the test tool on said axis; and
measuring the breaking force necessary to break said wire.

Such a device permits simulation of a pull test by breaking a wire. Generally speaking wire is extruded in a very consistent material content, shape and size, and moreover if solder wire is used it can closely replicate the material of the solder balls. The tool should be arranged to break the wire close to the mouth of the hole from which it protrudes so as to minimise wire bending; however contact between the tool and the fixed member should be avoided since any frictional force will mask the measured breaking force.

Thus the invention permits a relative standard to be determined with reference to a consistent test material, namely an extruded wire of known composition and size, and an absolute standard to be determined in the case of the test wire being of the same material as the electrically conductive balls which are repeatedly tested in use. The use of a wire of similar material may be sufficient to give results close to the absolute standard, in cases where exactly the same wire composition is unavailable. Information about the physical and material properties of wire is generally widely available, so that calibration to absolute values is facilitated.

Such a comparison method can be consistent and repeatable. By indexing the wire through the hole, the same test can be repeated time and again. A pull test device can be calibrated and re-calibrated as often as is desirable in order to give confidence that the forces which are detected are accurate.

Additionally, the performance of two nominally identical pull test devices can be compared so as to permit any variation to be recorded, or to be adjusted out

In a refinement, the test tool may be accelerated into contact with the protruding wire so as to simulate an impact test. For such a purpose the method may include the step of providing a rest on said pull axis for abutment with the tool prior to performing the test. The method may further include the step of adjusting the position of the rest relative to the wire. The step may also be used to position the abutment face just distal of the wire hole.

In a further refinement the method includes the step of selecting a test tool having substantially the same mass as a conventional jaw device used for pull testing. This refinement ensures that similar inertia loads are exerted by both the tool and the jaw device.

According to a second aspect, the invention provides apparatus for comparison testing of a pull test device having an output indicative of the pulling force exerted thereby, the apparatus comprising an anvil having a hole therethrough, said hole being selected for close sliding fit of a test specimen such as a wire, a test tool adapted for mounting on a pull test device and having an abutment face, and low friction support means for constraining said test tool for movement on said pull axis whereby movement of said tool on said axis causes said abutment face to break a wire protruding from said hole, said apparatus including means to measure the breaking force required to break the wire.

In the preferred embodiment, the anvil has a projection face parallel to said axis and from which the wire projects in use. The low friction support means may comprise one or more rollers bearing against one or more flanks of said tool. The abutment face preferably terminates at a perpendicular edge immediately adjacent said projection face.

The apparatus may further be provided with a tool rest, preferably an adjustable rest, having a support surface on and perpendicular to said axis, and facing in the same direction as said abutment face. Such a rest provides a start position from which the tool is brought into wire contact. The start position may be distant from the hole to allow acceleration of the tool for an impact test.

Other features will be apparent from the following description of a preferred embodiment shown by way of example only in the accompanying drawings in which:

FIG. 1 is a schematic side elevation of test apparatus according to the invention in the rest condition;

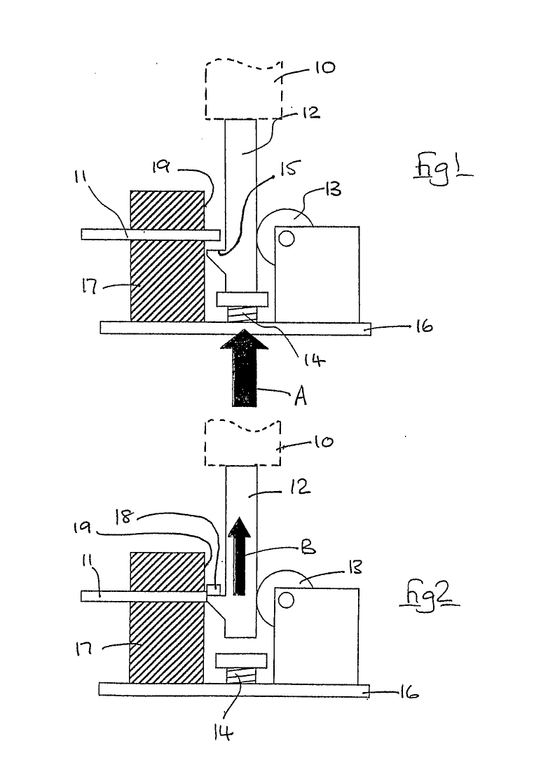

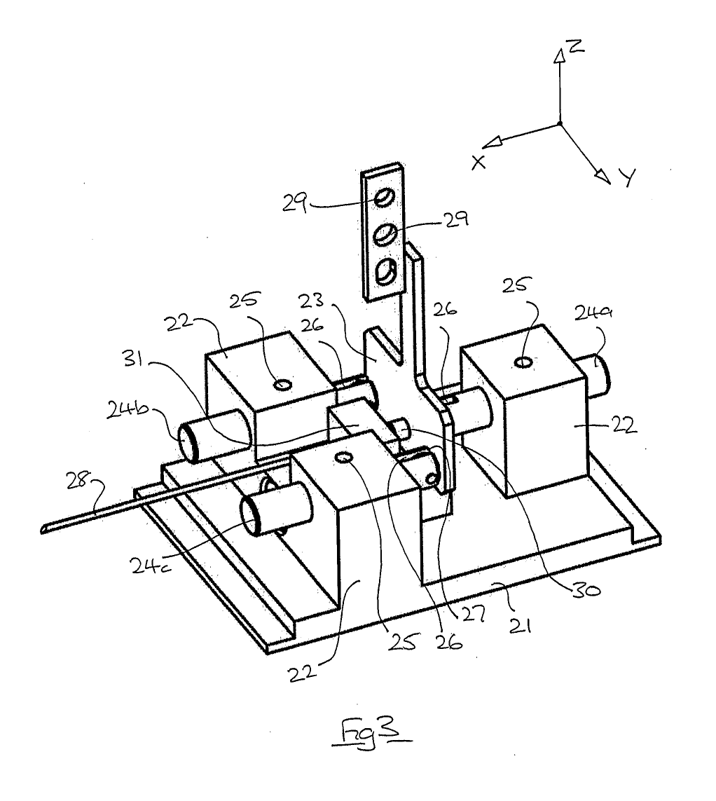

FIG. 2 shows the apparatus of FIG. 1 with a test in progress;

FIG. 3 is a perspective view of test apparatus according to the invention.

With reference to FIG. 1 a pull shaft 10 a test cartridge, or test head, such as the one shown in U.S. Pat. No. 6,301,971. is indicated schematically in dotted outline. The precise form of the cartridge 10 is not important except that it includes means for detecting a pull force exerted by the cartridge upon as test tool. A typical test tool has a jaw or gripper adapted to be closed upon a test specimen, so that a pull force can be exerted in the direction of arrow A. Force measurement may be for example by strain gauge(s) having an electrical output. Such a test cartridge requires calibration against a standard, and the present invention provides a means of making such calibration.

The invention provides an alternative test tool 12, which replaces the gripper, and has an abutment face 15 which is perpendicular to the pull axis. A baseplate 16 has an anvil 17 mounted thereon and which includes a hole of generally constant diameter, having a longitudinal axis perpendicular to the pull axis, through which a wire 11 can pass. The wire fits closely to the hole so as to be freely movable therethrough, but not having excess lateral play.

A screw 14 is threaded into the baseplate 11, to provide a rest 14 which constitutes a lower support for the test tool. The screw 14 can be adjusted up or down to set the position of the rest.

A roller 13 provides low-friction lateral support by running on a flank face of the tool 12 as illustrated. If desired or necessary similar rollers could be provided in other planes to ensure lateral stability, and means could be provided to prevent arcuate movement of the tool about the pull axis, for example by running a wheel in a slot of the tool. In general, the minimum support commensurate with function is sufficient, in order to reduce friction to a minimum. It will be understood that a tension test has good inherent lateral stability.

FIG. 2 shows a pull test in operation. The wire 11 is indexed through the anvil 17, and is broken by the tool in an upward movement B so that a portion 18 breaks away. By indexing a fresh portion of wire through the hole, the test may be repeated. Due to the consistent nature of wire, the results of such a comparison test are very repeatable, and may be related to absolute values of measured force according to the known physical properties of the wire.

It will be understood that the test apparatus is appropriate for different grades of wire, and for different diameters of wire by substitution of the anvil 17. Particularly in respect of solder, the test wire can be of exactly the same composition as a solder ball.

In order to ensure that the test tool replicates as closely as possible the gripping tool, it is preferable that both be of substantially the same mass.

The apparatus is suitable for substantially static testing, whereby the abutment face is at or against the wire surface prior to exertion of a steady pull on the test tool.

Alternatively a dynamic test may allow the abutment face to accelerate into contact with the wire over a distance determined by the position of the rest 14. The means of driving the test tool in the pull direction may of course be adjustable to ensure a desired acceleration and/or terminal velocity, and the means of providing such drive is conventional, for example a three-axis machine tool drive as may be found in a milling machine. Thus in use, the test tool is accelerated against the wire from a start position determined by the position of the adjustable rest 14, the terminal velocity being determined according to the acceleration of the tool and the distance between the rest and wire. The co-ordinates of the test tool can be determined via conventional displacement transducer technology of the kind found in machine tools, and the speed/acceleration characteristic determined from the change of co-ordinates with respect to an electronic clock of the kind found in any conventional computer processor.

As will be explained, the position of the roller 13 may be adjusted laterally to control the distance between the contact edge of the abutment face 15, and the protrusion face 19 of the anvil 17.

FIG. 3 illustrates in perspective view a typical embodiment of a test apparatus according to the invention. The respective X, Y and Z axes are shown.

A base plate 21 has three support blocks 22 formed or mounted thereon in a triangular formation about a test tool 23 movable on demand on the Z axis. Each block 22 defines a through passage in the X direction for a cylindrical roller support 24a, 24b, 24c, and the protrusion of each support is locked by means of respective grub screws 25.

The ends of the supports 24 which are adjacent the tool 23 are slotted, and aligned in the Z axis. Within each slot 26 is a roller 27 rotatable about the Y axis, as illustrated.

The supports 24 are in use adjusted axially so that the respective rollers bear on the test tool to restrict movement thereof other than in the Z direction, as will be further explained.

Also mounted on the base plate 21 is an anvil 31 of the kind illustrated in FIGS. 1 and 2, and through which a wire 28 protrudes. A means of advancing the wire 28 is provided, but not illustrated.

The test tool 23 comprises a plate having an upwardly directed limb for attachment to a test cartridge via mounting holes 29, and an abutment face 30 for contact with the protruding portion of the wire 20. The abutment face 30 may be constituted by an attachable component, in which case substitution of alternative abutment profiles is possible. The edge of the abutment face which is close to the anvil defines the plane of wire breakage.

In use the roller support 24a is adjusted axially and locked to maintain the test tool 23 at a desired separation from the front face of the anvil. This separation is selected to ensure repeatability of tests and to avoid the risk of the test tool 23 dragging on the anvil 31.

The two roller supports 24b, 24c are then adjusted axially to bear upon the opposite side of the test tool 23, as illustrated, and locked so as to resist arcuate movement of the test tool about the Z axis.

As illustrated, the supports 24b, 24c are arranged on either side of the axis of the support 24a, but other locations are commensurate with preventing such arcuate movement. The adjustment of the supports allows the rollers 27 to bear lightly on the test tool to reduce friction to a minimum whilst eliminating unwanted free play.

In use, the connection of the test tool to the test cartridge is not stiff in the X-axis, so as to ensure that adjustment of the support 24a does not impose a frictional load.

Throughout this application reference is made to electrical connection made via solder balls, and to the testing of the bond strength of such solder balls. It will be understood however that other electrically conductive materials may be used to form balls which are adapted to be re-flowed or welded on attachment of a mating component. The method and apparatus of this invention is particularly applicable to such other materials if available in a suitable wire form, but a wire of different material is still useful in providing a standard to calibrate and check calibration of a test cartridge. In addition, the test apparatus can be used with test specimens other than wires.

It is intended to be understood that this invention is not limited to the embodiments described herein, and that variants, obvious to those skilled in the art, can be made which are within the spirit and scope of the claims appended hereto.

1. A method for determining performance of a pull test device and comprising the steps of:
determining a pull axis of a pull test device,
fitting to said device a test tool having an abutment face facing the direction of pull;
providing adjacent an edge of said face a relatively fixed member having a through hole therein having a longitudinal axis perpendicular to said pull axis;
inserting a close fitting test specimen through said hole to protrude therefrom on the test tool side;
supporting said tool in a low friction manner against forces tending to cause misalignment from said axis
breaking said test specimen with said abutment face by movement of the test tool on said axis; and
measuring the force required to break the test specimen.

2. A method according to claim 1 and including the step of moving said tool into touching contact with said test specimen prior to performing the test specimen breaking step.

3. A method according to claim 1 and including the step of accelerating said tool into said test specimen to cause breaking thereof.

4. A method according to claim 1 and including the step of supporting said tool on an abutment at a distance from said test specimen, so as to prevent movement in a direction opposite to the direction of pull prior to said test specimen breaking step.

5. A method according to claim 4 and including the step of adjusting said abutment to obtain a desired spacing of said tool and test specimen prior to said test specimen breaking step.

6. A method according to claim 1 wherein said test device includes a pull test gripper adapted to grip and pull an electrically conductive ball deposit of an electrical component, said method including the step of substituting said gripper with a test tool of substantially the same mass.

7. A method according to claim 1 and including the additional step of setting said edge at a predetermined distance from the mouth of said hole perpendicular to said axis.

8. A method according to claim 1 and including the step of selecting a test specimen of wire.

9. Apparatus for comparison testing of a pull test device having an output indicative of the pulling force exerted thereby, the apparatus comprising an anvil having a hole therethrough, said hole being selected for close sliding fit of a test specimen, a test tool adapted for mounting on a pull test device and having an abutment face, and a low friction support for constraining said test tool for movement on said axis whereby movement of said tool on said axis causes said abutment face to break a test specimen protruding from said hole, and a measuring device for measuring the force required to break the test specimen.

10. Apparatus according to claim 9 and further including a setting device for said abutment face and adapted to ensure test specimen-shearing at a pre-determined test specimen protrusion.

11. Apparatus according to claim 10 wherein said low friction support comprises said setting device.

12. Apparatus according to claim 9 wherein said anvil has a projection face parallel to said axis and from which said test specimen projects in use.

13. Apparatus according to claim 9 wherein said low friction support is adapted to prevent arcuate movement of said test tool about said pull test axis.

14. Apparatus according to claim 9 wherein said low-friction support comprises one or more rollers bearing against one or more flanks of said test tool.

15. Apparatus according to claim 14 and having a plurality of rollers rotatable about parallel axes.

16. Apparatus according to claim 15 wherein said parallel axes are perpendicular to said pull test axis.

17. Apparatus according to claim 15 wherein said rollers bear on opposite sides of said test tool.

18. Apparatus according to claim 9 and further including a tool rest for said tool, said rest being substantially perpendicular to said pull test axis and defining a start position for said tool.

19. Apparatus according to claim 18 wherein said tool rest defines an abutment surface for said tool, said surface being arranged to define a fixed distance between said abutment face and said test specimen, in use.

20. Apparatus according to claim 18 wherein said tool rest is adjustable on said pull test axis so as to change the rest position of said tool.

21. Apparatus according to claim 9 and wherein said hole is selected for a close sliding fit of a wire.
